(19) United States
(12) Patent Application Publication
(10) Pub. No.: US 2006/0005591 A1
(43) Pub. Date: Jan. 12, 2006

(54) Electrically-releasable lock

(76) Inventor: Jean-Marc Belmond, St. Jean Le Blanc (FR)

Correspondence Address: CARLSON, GASKEY & OLDS, P.C., 400 WEST MAPLE ROAD, SUITE 350, BIRMINGHAM, MI, 48009, US

(21) Appl. No.: 11/146,429

(22) Filed: Jun. 6, 2005

(30) Foreign Application Priority Data
Jun. 18, 2004 (FR) 04 06 638

(51) Int. Cl. E05B 47/00

(52) U.S. Cl. 70/277

(57) ABSTRACT

An electrically-releasable lock includes emergency mechanical linkages which are engaged in the event of a failure of the power supply to the lock. The lock also has an actuator for disengaging the emergency mechanical linkages to enable the mechanical operation to take the place of defective electrical operation in the event of a power failure. This is advantageous if the user of the vehicle wants to abandon the vehicle securely.

### REFERENCE TO RELATED APPLICATIONS

This application claims priority to French Patent Application 04 06 638 filed on Jun. 18, 2004.

### BACKGROUND OF THE INVENTION

The present invention relates generally to an electrically-releasable lock.

An electrically-releasable lock is electrically operated, and the operational power supply comes, for example, from the vehicle's battery. When a power failure occurs, for example as a result of the vehicle being involved in an accident, an emergency mechanical method of operating the lock may be provided. For example, discharge from a capacitor may momentarily supply power to a system inside the lock, allowing it to be opened mechanically so that the passengers can exit the vehicle. The problem which arises is that the lock's emergency power supply is then insufficient to reactivate the functions of the electrical lock and keep the door shut if the occupants want to abandon the vehicle.

A need therefore exists for an electrical lock which can be reactivated after an emergency operation.

### SUMMARY OF THE INVENTION

The present invention provides an electrically-releasable lock having emergency mechanical linkages which are brought into action in the event of a failure in the lock's power supply. The lock also has an actuator for disengaging the emergency mechanical linkages.

In one embodiment, the emergency mechanical linkages are automatically engaged in the event of a failure in the lock's power supply. In another embodiment, the actuator is manually activated. In another embodiment, the actuator rotates. In yet another embodiment, the disengagement of the mechanical linkages cannot be reversed by the actuator. In another embodiment, the actuator has a spring arm for returning the actuator to an initial position.

The invention also provides a vehicle door including the lock as described previously, and the disengaging actuator is on the edge of the door.

The invention also provides a method for securing an electrical lock whose power supply has failed. The lock includes emergency mechanical linkages and an actuator for disengaging the mechanical linkages. The method includes an actuator-activation stage that changes the lock from an operating state in which the emergency mechanical linkages are engaged to a secured state in which the mechanical linkages are disengaged.

In one embodiment, the mechanical linkages automatically engage when the power fails. In another embodiment, the actuator is activated manually.

Other characteristics and advantages of the invention will become apparent when reading the following detailed description of embodiments thereof, given by way of example only and with reference to the drawings.

### BRIEF DESCRIPTION OF THE DRAWINGS

FIG. 1 is a perspective view of an electrical lock in normal electric operation;

FIG. 2 is a perspective view of the electrical lock in emergency mechanical operation; and

FIG. 3 is a state diagram for the electrical lock.

### DETAILED DESCRIPTION OF PREFERRED EMBODIMENTS

The invention provides an electrically opening lock including emergency mechanical linkages which are engaged in the event of a power failure. The lock also includes an actuator for disengaging the emergency mechanical linkages. The lock allows the mechanical linkages which have been engaged to be re-disengaged to enable the lock's mechanical operation in place of its defective electrical operation in the event of a power failure. This is advantageous if the user of the vehicle wants to abandon the vehicle safely.

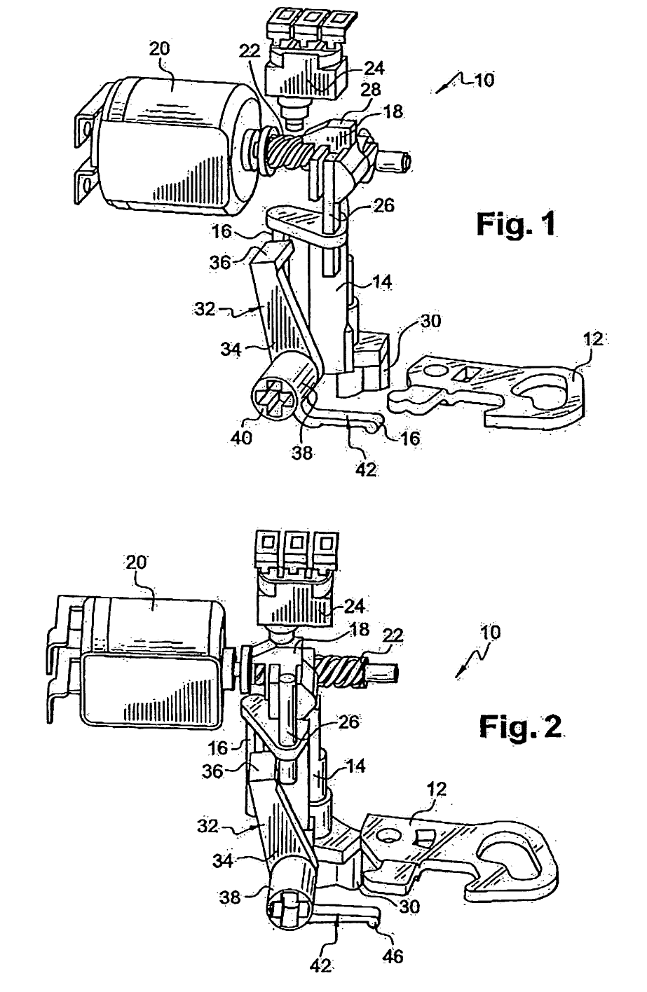

FIG. 1 shows a perspective view of an electrical lock 10 in normal electric operation, i.e., an electrically-releasable lock. Only the cam-shaped release member 12 which cooperates with a claw of the latch mechanism is shown. The electrical lock 10 also includes emergency mechanical linkages which are engaged in an emergency. Of the emergency mechanical linkages, the emergency lever 14 is illustrated. In FIG. 1, the mechanical linkages are not engaged, i.e., the lower part of the lever 14 does not come into contact with cam-shaped release member 12.

The emergency mechanical linkages are preferably automatically engaged, which avoids the user having to engage the linkages himself. This makes it easier to exit the vehicle. The emergency mechanical linkages, in this case the lever 14, are engaged by an emergency power supply, which is not illustrated. If a failure in the power supply occurs while the vehicle is moving and the electrical lock 10 cannot be activated, the emergency power supply still allows the emergency mechanical linkages to be engaged. When the mechanical linkages are engaged, the electrical lock 10 can be mechanically activated, and the passengers can exit the vehicle. However, the emergency power supply replaces the normal power supply only for a short time. For example, the emergency power supply only allows the mechanical linkages to engage once to limit the cost of the emergency power supply.

The power supply is, for example, a capacitor whose discharge makes up for the defective electrical supply of the electrical lock 10. Once discharged, the capacitor can then no longer supply power to the electrical lock 10. In FIG. 1, the lever 14 is rotatably mounted around a shaft 16, and the rotation of the lever 14 around the shaft 16 allows the mechanical linkages to engage.

The electrical lock 10 includes an emergency motor 20 activated by the emergency power supply. The emergency motor 20 drives the lever 14 to engage the mechanical linkages. The emergency motor 20 is connected to the lever 14 by a screw 22 and a nut 18. The nut 18 is connected to a pin 26 of the lever 14, and the pin 26 rotates with respect to the nut 18. Moreover, the electrical lock 10 includes a switch 24 that turns on to indicate that the emergency mechanical position is activated to diagnose proper operation of the emergency system. In FIG. 1, the switch 24 is not turned on. The switch 24 can be turned on by the nut 18. The nut 18 has a surface 28 which comes into contact with the switch 24. One face of the surface 28 can be bevelled to facilitate contact between the nut 18 and the switch 24.

The operation of engaging the mechanical linkages will now be described and shown in FIG. 2. FIG. 2 shows a perspective view of the electrical lock 10 in emergency operation. The lever 14 is engaged in the sense that it can intercept the rotational movement of cam-shaped release member 12 and thus come into contact with it. Actuation of a door handle mechanically operates the latch by means of the lever 14 and the cam-shaped release member 12.

To ensure that the mechanical linkages engage, the emergency motor 20 is activated by the emergency power supply, preferably automatically, as soon as a power failure occurs. The emergency motor 20 rotates the screw 22, which allows the nut 18 to move. The nut 18 is prevented from rotating when the screw 22 is moved by the pin 26 of the lever 14. Thus, the nut 18 is moved in translation along the screw 22 towards the emergency motor 20. The translation of the nut 18 allows the switch 24 to be turned on by means of the surface 28. The switch 24 turning on indicates that the mechanical linkages are in the engaged state during stages that diagnose proper operation of the emergency system. The translation of the nut 18 also causes the lever 14 to rotate about its axis by means of the pin 26. On completing its rotation, the lever 14 reaches the engaged position, and a pusher 30 at the lower end of the lever 14 comes into contact with the cam-shaped release member 12 when the release lever 12 rotates during mechanical release. In this engaged position of the lever 14, the electrical lock 10 is in emergency operation when it can be mechanically activated to open without limitation.

The electrical lock 10 also includes a disengaging actuator 32, shown in FIGS. 1 and 2. The actuator 32 allows the mechanical linkages to be re-disengaged so that the latch can no longer be mechanically activated to open. The actuator 32 ensures that the mechanical linkages disengage even when the electrical operation of the electrical lock 10 is defective or inactive as a result of a power failure. The actuator 32 returns the electrical lock 10 to the electrical operation position, and the electrical lock 10 then cannot be activated again until the power supply to the electrical lock 10 is restored. Thus, if the door is closed again while the mechanical linkages are disengaged, the latch is in the normal operation position but is inactive. It is therefore impossible to open the door, allowing the vehicle to be abandoned until a repair crew can restore the power.

The actuator 32 can be manually activated. The actuator 32 can therefore be activated when there is no power supply, particularly if the power supply is defective.

One embodiment of the actuator 32 is shown in the drawings. The actuator 32 can include an arm 34 for activating a shoulder 36. In FIG. 1, the actuator 32 is in the off-position and does not contact the disengaged lever 14. When the mechanical linkages are engaged as in FIG. 2, the lever 14 contacts the actuator 32. Activating the actuator 32 allows the lever 14 to be returned to the position shown in FIG. 1.

In this embodiment, the actuator 32 can be rotated to disengage the lever 14. To this end, the actuator 32 can be provided with a thumb wheel 38 connected to one end of the arm 34. In the position in FIG. 2, rotation of the thumb wheel 38 moves the lever 14 by means of the shoulder 36. The shoulder 36 can, for example, come into contact with the pin 26 by which the nut 18 rotates the lever 14. Contact with the pin 26 by the lever 14 (made of plastic, for example) allows a 90° reverse motion in the example of construction envisioned. Since the thread profile of the screw 22 is reversible, the disengaging movement of the lever 14 allows the nut 18 and the emergency motor 20 to be moved in the opposite direction to the engaging direction of the mechanical linkages. The thumb wheel 38 can have an opening 40 into which a tool is inserted to rotate the thumb wheel 38. The opening can be shaped such that the thumb wheel 38 can only be moved by a special tool.

The actuator 32 may, for example, be activated from the outside of the door to which the electrical lock 10 is fitted. When the user opens the door by mechanically actuating the door handle thanks to the engaged mechanical linkages, the user can then activate the actuator 32 to disengage the mechanical linkages and close the door securely. The actuator 32 is, for example, positioned so that the thumb wheel 38 is accessible on the edge of the door, which facilitates access to the actuator 32.

The actuator 32 can only act upon the lever 14 to disengage the mechanical linkages. The disengagement of the mechanical linkages cannot be reversed by the actuator 32, that is, it is not possible to engage the mechanical linkages using the actuator 32 (it is still possible to engage the mechanical linkages, however, via the emergency motor 20). This allows the vehicle to be secured in the sense that the actuator 32 cannot be picked by a thief to activate the latch mechanical and make it easy for him to enter the vehicle.

The actuator 32 can include a return element 42 for returning the actuator 32. This allows the actuator 32 to be placed in contact with the lever 14 only when the lever 14 is engaged. Thus, the lever 14 can only be moved by the actuator 32 when the lever 14 is engaged. According to FIGS. 1 and 2, the return element 42 is a spring arm. One end 44 of the spring arm is connected to the actuator 32, and the other end 46 of the spring arm is in contact with a stop which is not illustrated. In FIGS. 1 and 2, the actuator 32 is in the neutral position, and the return element 42 is not acted upon. When the lever 14 is engaged, from FIG. 1 to FIG. 2, the lever 14 comes into contact with the actuator 32. To disengage the lever 14, the actuator 32 is activated by a rotation to the right, as shown in FIG. 2. As the end 46 is against its stop, the return element 42 is therefore subject to a bending movement when the actuator 32 rotates. When the lever 14 is disengaged again, the actuator 32 is released and elastically returned by the return element 42 to the neutral position shown in FIG. 1.

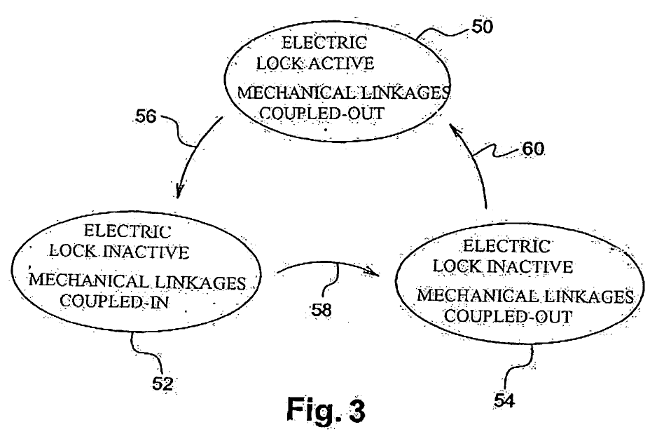

FIG. 3 shows a state diagram for the electrical lock 10. This figure shows a method for securing the electrical lock 10. Three states 50, 52, 54 of the electrical lock 10 are represented. The state 50 relates to the normal electrical operation of the electrical lock 10, the latch being electrically active and the mechanical linkages being disengaged and inactive. The power supply to the electrical lock 10 is thus working. The state 52 relates to the emergency operation of the electrical lock 10, the latch being electrically inactive and the mechanical linkages being engaged and active. The power supply to the electrical lock 10 has thus failed. The state 54 relates to the securing of the electrical lock 10, the mechanical linkages being engaged and inactive. The power supply to the electrical lock 10 having failed, the electrical lock 10 is also electrically inactive.

The transition from the state 50 to the state 52 following the arrow 56 occurs when the power supply to the electrical lock 10 fails when the vehicle is moving, for example as the result of an accident. This transition can be achieved automatically. The transition from the state 52 to the state 54 following the arrow 58 occurs by activating the actuator 32. In the state 54, the electrical lock 10 is electrically inactive, and the mechanical linkages are disengaged. The latch can no longer be activated and is therefore secure. The transition following the arrow 58 is possible even when the lock is electrically inactive. The actuator 32 is preferably manually activated by the user. Moreover, the transition following the arrow 58 cannot be reversed using the actuator 32. Finally, the transition from the state 54 to the state 50 following the arrow 60 is achieved by restoring the power supply to the electrical lock 10. The power supply to the electrical lock 10 allows the electrical lock 10 to become active again, and to disengage the mechanical linkages.

Of course, the present invention is not limited to the embodiments described by way of example. Thus, the actuator is not limited to a rotational movement, but includes any other movement, such as translation, to disengage the mechanical linkages.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. An electrically-releasable lock comprising:
emergency mechanical linkages which are engaged if a power supply to the electrically-releasable lock fails; and
an actuator for disengaging the emergency mechanical linkages.

2. The lock according to claim 1, wherein the emergency mechanical linkages are automatically engaged if the power supply to the electrically-releasable lock fails.

3. The lock according to claim 1, wherein the actuator is manually activated.

4. The lock according to claim 1, wherein the actuator rotates.

5. The lock according to claim 1, wherein the actuator cannot reverse disengagement of the emergency mechanical linkages.

6. The lock according to claim 1, wherein the actuator includes a spring arm for returning the actuator to an initial position.

7. A vehicle door comprising:
an electrically-releasable lock including:
emergency mechanical linkages which are engaged if a power supply to the electrically-releasable lock fails, and
an actuator for disengaging the emergency mechanical linkages, wherein the actuator is on an edge of the vehicle door.

8. A method for securing an electrical lock when a power supply has failed, the electrical lock including emergency mechanical linkages and an actuator for disengaging the emergency mechanical linkages, the method comprising the step of:
changing a state of the electrical lock from an operating state in which the emergency mechanical linkages are engaged to a secured state in which the emergency mechanical linkages are disengaged.

9. The method according to claim 8, further including the step of automatically engaging the emergency mechanical linkages when a power failure occurs.

10. The method according to claim 8 further including the step of manually activating the actuator.
